(19) United States
(12) Patent Application Publication
(10) Pub. No.: US 2009/0254335 A1
(43) Pub. Date: Oct. 8, 2009

(54) MULTILINGUAL WEIGHTED CODEBOOKS

(75) Inventors: Raymond Brückner, Blaustein (DE); Martin Raab, Ulm (DE); Rainer Gruhn, Ulm (DE)

Correspondence Address: THE ECLIPSE GROUP LLP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 12/416,768

(22) Filed: Apr. 1, 2009

(30) Foreign Application Priority Data
Apr. 1, 2008 (EP) EP 08 006 690.5

(51) Int. Cl. G06F 17/20; G10L 15/00

(52) U.S. Cl. 704/8; 704/251; 704/270; 704/E15.003

(57) ABSTRACT

Examples of methods are provided for generating a multilingual codebook. According to an example method, a main language codebook and at least one additional codebook corresponding to a language different from the main language are provided. A multilingual codebook is generated from the main language codebook and the at least one additional codebook by adding a sub-set of code vectors of the at least one additional codebook to the main codebook based on distances between the code vectors of the at least one additional codebook to code vectors of the main language codebook. Systems and methods for speech recognition using the multilingual codebook and applications that use speech recognition based on the multilingual codebook are also provided.

### RELATED APPLICATIONS

This application claims priority of European Patent Application Serial Number 08 006 690.5, filed on Apr. 1, 2008, titled MULTILINGUAL WEIGHTED CODEBOOKS, which application is incorporated in its entirety by reference in this application.

### BACKGROUND OF THE INVENTION

1. Field of the Invention

The present invention relates to the art of speech recognition and, in particular, to speech recognition of speech inputs of different languages based on codebooks.

2. Related Art

Speech recognition systems include devices for converting an acoustic signal to a sequence of words or strings. Significant improvements in speech recognition technology, high performance speech analysis, recognition algorithms and speech dialog systems have recently been made allowing for expanded use of speech recognition and speech synthesis in many kinds of man-machine interaction situations. Speech dialog systems are providing a natural kind of interaction between an operator and some operation device.

The application of speech recognition systems includes systems for providing input such as voice dialing, call routing, document preparation, etc. A speech dialog system may be employed in a car, for example, to allow the user to control different devices such as a mobile phone, a car radio, a navigation system and/or an air condition. Speech operated media players represent another example for the application of speech recognition systems.

During verbal utterances in speech recognition, either isolated words or continuous speech may be captured by a microphone or a telephone, for example, and converted to analog electronic signals. The analog signals are subsequently digitized and usually subjected to spectral analysis. Representations of speech waveforms sampled typically at a rate between 6.6 kHz and 20 kHz may be derived from short term power spectra. Such speech waveforms represent a sequence of characterizing vectors containing values of what is generally referred to as features/feature parameters. The values of the feature parameters are used in further processing. For example, the values of the feature parameters may be used in estimating the probability that the portion of the analyzed waveform corresponds to, for example, a particular entry, such as a word, in a vocabulary list.

Speech recognition systems typically make use of a concatenation of allophones, which are abstract units of speech sounds that constitute linguistic words. The allophones may be represented by Hidden Markov Models (HMM) characterized by a sequence of states each of which has a well-defined transition probability. To recognize a spoken word, the systems compute the most likely sequence of states through the HMM. This calculation may be performed using the Viterbi algorithm, which iteratively determines the most likely path through an associated trellis.

The ability to obtain correct speech recognition of a verbal utterance of an operator is important to making speech recognition/operation reliable, and despite recent progress there remain demanding reliability problems. For example, there is room for improvement in the reliability of speech recognition in embedded systems that suffer from severe memory and processor limitations. These problems are further complicated when processing speech inputs of different languages. For example, a German-speaking driver of a car may need to input an expression, such as an expression representing a town, in a foreign language, such as English for example.

Speech recognition and control systems may include codebooks that may be generated using the (generalized) Linde-Buzo-Gray (LBG) algorithm or some related algorithms. However, codebook generation operates by determining a limited number of prototype code vectors in the feature space covering the entire training data which usually includes data of one single language.

Alternatively, data from a number of languages of interest may be included using of one particular codebook for each of the languages without any preference for a particular language. This creates a heavy data and processing load. In typical applications, however, not all of a number of pre-selected languages may be needed. Thus, there is a need for efficient speech recognition of speech inputs of different languages that do not place to great a demand on computer resources. There is also a need for improved generation of codebooks for multilingual speech recognition.

### SUMMARY

In view of the above, an example of a method is provided for generating a multilingual codebook. According to the example method, a main language codebook and at least one additional codebook corresponding to a language different from the main language are provided. A multilingual codebook is generated from the main language codebook and the at least one additional codebook by adding a sub-set of code vectors of the at least one additional codebook to the main codebook based on distances between the code vectors of the at least one additional codebook to code vectors of the main language codebook.

In another implementation of the invention, example methods and systems for speech recognition are provided. In an example method, a multilingual codebook is used in processing speech inputs. In an example system, a multilingual codebook generator is provided to generate the multilingual codebook used in the system.

In another implementation of the invention, example applications that use speech recognition systems and methods that recognize speech using a multilingual codebook are provided. Example applications include navigation systems used for example in automobiles, audio player devices, video devices and any other device that may use speech recognition.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a flowchart of an example method for generating a multilingual codebook.

FIG. 2 is a flowchart illustrating operation of an example method for reducing code vectors in a multilingual codebook by merging.

FIG. 3 is a schematic block diagram of an example speech recognition system.

FIG. 4 is a flowchart of an example method of speech recognition using a multilingual codebook generated as described with reference to FIG. 1.

FIG. 5 is a schematic diagram illustrating operation of an example method for generating a multilingual codebook.

### DETAILED DESCRIPTION

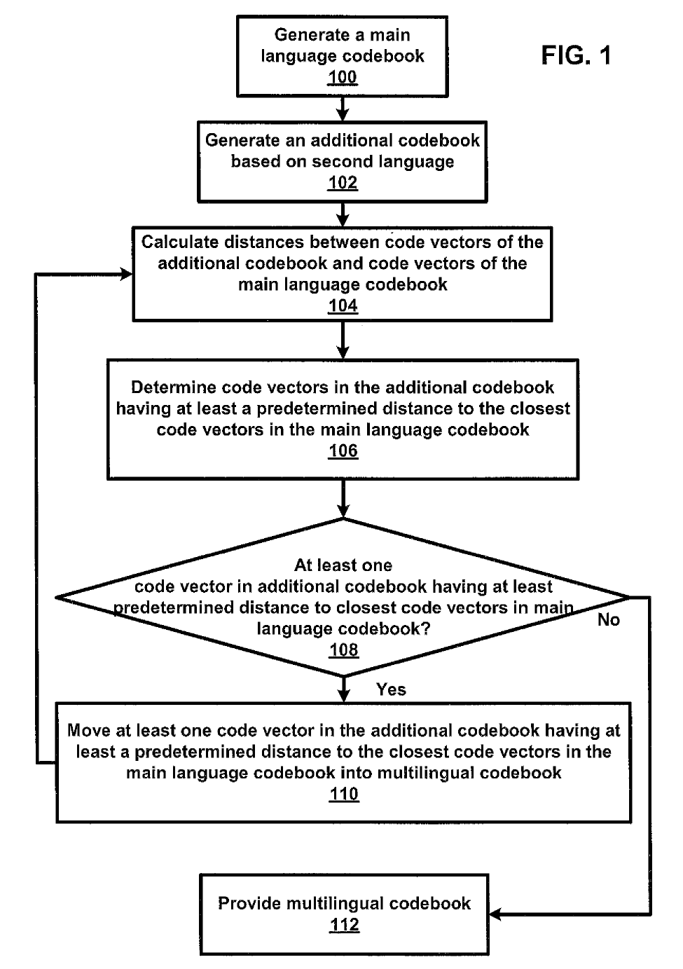

Example methods and systems for generating a multilingual codebook are described below with reference to FIGS. 1, 2 and 5. The multilingual codebook may then be used in a speech recognition system with requiring multiple space and resource consuming codebooks for various languages. The speech recognition system using the multilingual codebook may be used in a variety of applications. For example, speech recognition systems may be used in applications that use speech input from the user to perform functions.

FIG. 1 is a flowchart illustrating an example method for generating a multilingual codebook. A main language codebook is provided at step 100. The main language codebook is a codebook used in speech recognition systems for the language that a typical user would be expected to speak. For example, in a navigation system used in an automobile, the main language codebook is a codebook for a language spoken by its users. The automobile may be made for sale in Germany, for example. The main language codebook in the navigation system in the automobile is for the German language. At step 102, an additional codebook based on a second language is generated. The additional codebook is a codebook used for a language that is different from the main language but may include terms that may be spoken by a user that speaks the main language.

The main language codebook and the additional language codebooks may be generated as known in the art. The main codebook and additional codebooks include feature vectors, or code vectors, generated for the language of the codebook by some technique known in the art. The code vectors may be determined from a limited number of prototype code vectors in the feature space covering the entire training data. The training data usually includes data of one single language. For the generation of a codebook of one single particular language, feature (characteristic) vectors comprising feature parameters (e.g., spectral envelope, pitch, formants, short-time power density, etc.) extracted from digitized speech signals and the codebook may be generated as code vectors. Some mapping of these code vectors to verbal representations of the speech signals may be employed for speech recognition processing. Examples of known methods for generating the main language codebook and the additional codebooks include the Linde-Buzo-Gray (LBG) algorithm or some related algorithms. A multilingual codebook as described below allows for speech recognition of a main language and of sub-sets of one or more other languages.

In addition, the main language codebook and/or the at least one additional codebook may be generated based on utterances by a single or some particular users such that speaker enrollment is employed for better performance of speech recognition. In this case, the code vectors of the at least one additional codebook correspond to utterances of a speaker in a language that is not his mother language. This may improve the reliability of the speech recognition process in cases where the speaker/user of the speech recognition system is not very familiar with the foreign language he may have to use in particular situations. Alternatively, the main language codebook and/or the at least one additional codebook might be generated on the basis of utterances of native model speakers.

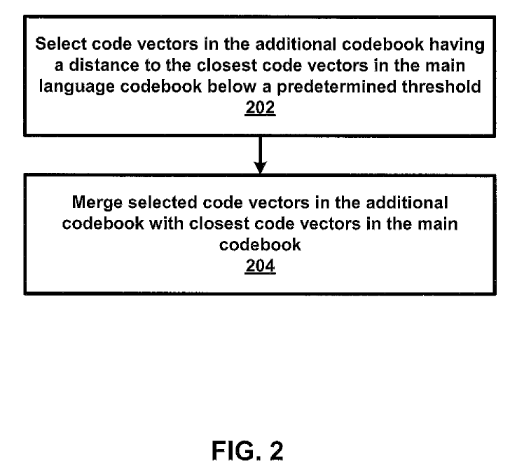

In an example implementation, distances between all code vectors of the at least one additional codebook and code vectors of the main language codebook (“main language code vectors”) are determined at step 104. The code vectors in the codebooks may be Gaussians, or vectors in a Gaussian density distribution. A distance between code vectors may be determined by computing a Mahalanobis distance or by computing a Kullback-Leibler divergence or by minimizing the gain in variance when a particular additional code vector is merged with different particular code vectors of the main language codebook (as described below with reference to FIG. 2). Use of the Mahalanobis distance has been found to provide suitable results. However, depending on different languages and employed samples of code vectors, other distance measures may provide an equally appropriate choice.

In an example implementation, at least one code vector of the at least one additional codebook that exhibits a predetermined distance from the closest neighbor of the main language codebook is added to the main language codebook. The closest neighbor of the main language codebook is the code vector of the main language codebook that is closest to the at least one code vector. The predetermined distance may be the largest distance of the distances of the code vectors of the at least one additional codebook to the respective closest neighbors of the main language codebook.

In example implementations of methods for generating a multilingual codebook, the multilingual codebook may be generated by iteratively adding code vectors to the main language codebook. The distances of the code vectors of the at least one additional codebook to the respective closest neighbors of the main language codebook may be determined and the one code vector of the at least one additional codebook with the largest distance may then be added to the main language codebook. Subsequently, distances of the code vectors of the at least one additional codebook to the respective closest neighbors of the main language codebook may again be determined and the one code vector of the at least one additional codebook with the largest distance may be added to the main language codebook repeatedly until a selected limit is reached.

The iterative process of adding code vectors to the multilingual codebook may be continued in accordance with a desired level of recognition performance. The level of performance may be determined by determining a minimum distance threshold and selecting a basis on which to end iterations according to a number of code vectors in the additional codebooks having distances above the predetermined minimum distance threshold. For example, the iterative generation may be completed when it is determined that none of the remaining code vectors of the at least one additional codebook exhibit a distance to the closest neighbor of the main language codebook above a predetermined minimum distance threshold. This predetermined minimum distance threshold may be determined to be the distance below which no significant improvement of the recognition result is to be expected. For example, the predetermined distance threshold may be determined to be the distance at which the addition of code vectors with such small distances does not result in better recognition reliability. This iterative process and threshold for ending the process allows for a number of code vectors in the multilingual codebook that is as small as possible for a targeted recognition performance.

Referring to FIG. 1, the additional code vectors having at least a predetermined distance to the closest main language code vectors are determined at step 106. Step 106 is performed iteratively along with the following steps in the example method shown in FIG. 1. Decision block 108 determines whether the iterative process is to be completed by checking for at least one code vector in the additional codebook that has at least the predetermined distance to the closest code vectors in the main language codebook. If at least one such code vector was found at decision block 108, the at least one code vector in the additional codebook having at least a predetermined distance to the closest code vectors in the main language codebook is moved into the main language codebook at step 110. At step 110, only a single code vector in the additional codebook having at least the predetermined distance to the closest neighbor may be moved to the multilingual codebook. In another example, more than one code vector may be moved. In addition, if multiple code vectors have at least the predetermined distance to the same closest neighbor, the code vector having the largest distance to the closest neighbor may be selected over the others. After the addition of the closest code vector, or vectors, in the additional language codebooks, another iteration is started by calculating distances between the code vectors of the additional codebook and the main language code vectors at step 104. The process continues iteratively between steps 104 and steps 110.

If at decision block 108, no code vectors in the additional language codebooks were found to be at least the predetermined distance from the closest neighbors in the main language codebook, the multilingual codebook is generated at step 112.

FIG. 2 is a flowchart illustrating an example of merging code vectors in the additional codebook. During the calculation of distances between the code vectors in the additional language codebooks and the closest neighbors in the main language codebook, at step 104 for example, the calculated distances may be checked to determine distances that are below a predetermined merging threshold. This check may be performed to determine if the code vectors in the additional language codebook should be merged with a corresponding closest neighbor in the main language codebook. As shown in FIG. 2 at step 202, the code vectors in the additional codebook having a distance to a closest neighbor in the main language codebook below the predetermined merging threshold are identified selected. At step 204, the selected code vectors in the additional codebook are merged with the corresponding closest neighbor. Two code vectors may be merged by replacing both the selected code vector from the additional language codebook and the corresponding closest neighbor with a merged code vector that would have been estimated from the training samples of both the main language codebook and the additional language codebook that resulted in the code vectors that are merged. The merged code vector is added to the main language codebook. This additional process of merging code vectors further minimizes the size of the multilingual codebook ultimately generated resulting in further savings of memory and computational resources.

The multilingual codebook generated in the example method shown in FIG. 1 may be used for automated (machine) speech recognition of utterances of different languages corresponding to the main language codebook and additional codebooks. One single multilingual codebook is generated to replace the at least two codebooks for use in the speech recognition process. In particular, a reduced number of code vectors of the at least one additional codebook is added to the main language codebook thereby reducing the demand for computational resources in the speech recognition system. The savings in demand for computational resources such as processor load and memory may be particularly important in the context of embedded systems, such as for example, navigation systems installed in vehicles. For example, the multilingual codebook generated as described above may be used in a vehicle navigation system installed in an automobile manufactured for the German market. The main language is German. However, when the driver leaves Germany heading to France, for example, a speech input of a destination in France, say a French town, may be successfully recognized, if the at least one additional codebook used to in generating the multilingual codebook corresponds to French.

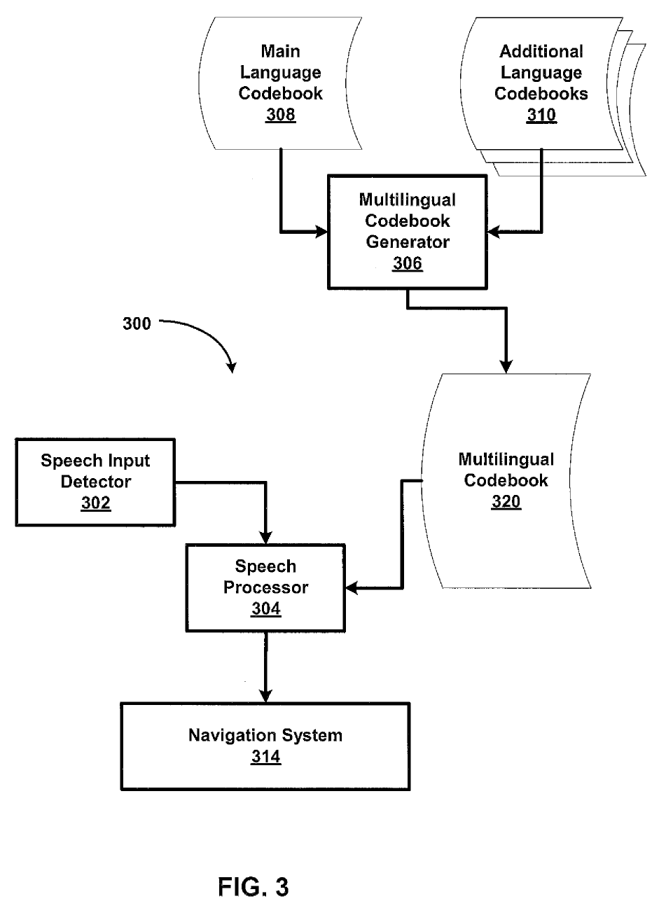

The multilingual codebook generated as described above with reference to FIGS. 1 and 2 may be used in a speech recognition and/or control system, which may be further used in an application. FIG. 3 is a schematic block diagram of an example speech recognition system 300. The example system 300 includes a speech input detector 302, a speech processor 304, and an application, such as a navigation system 314. The speech input detector 302 detects speech and processes the speech input as is known in the art for use by the speech processor 304. The speech processor 304 processes the speech input using a multilingual codebook 320. The multilingual codebook 320 may be generated by a multilingual codebook generator 306 that operates as described above with reference to FIGS. 1 and 2. The multilingual codebook generator 306 may include as inputs, a main language codebook 308 and at least one additional language codebooks 310. The multilingual codebook generator 306 may be used in a manufacturing step to generate the multilingual codebook 320 in a memory device to be installed in the speech recognition system 300. The speech recognition system 300 may provide a decoded speech output to the navigation system 314.

The application in FIG. 3 is a navigation system 314. However, other applications may be used. For example, an audio player (for example, an MP3 player) or a video device may include a speech recognition system such as the speech recognition system 300 shown in FIG. 3 to provide voice control of audio devices. Other players may be used as well, such as players that play other media such as WMA, OGG, etc.

The application in FIG. 3 may also be a cell phone or a Personal Digital Assistant (PDA) or a smartphone (PDA phone) that uses speech recognition. The Personal Digital Assistant (PDA) or smartphone (PDA phone) may both include a Personal Information Manager having a scheduler module (appointment calendar) and an address book. The speech recognition may also be incorporated in an electronic organizer, in particular, in a PalmTop™ or BlackBerry™.

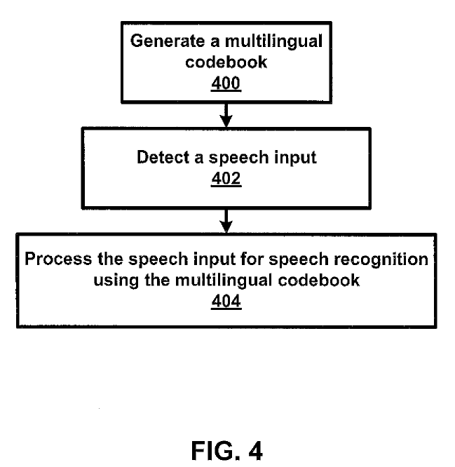

FIG. 4 is a flowchart of an example method of speech recognition using a multilingual codebook generated as described with reference to FIG. 1. The example method includes generating the multilingual codebook at step 400. The multilingual codebook may be generated using the example method described above with reference to FIGS. 1 and 2. It is noted that the multilingual codebook may be generated prior to manufacturing the speech recognition system. For example, the multilingual codebook may be generated as described above and provided in the speech recognition system as a codebook in memory of an embedded system. In the speech recognition method, a speech input may be detected at step 402. The process of speech recognition for the speech input may then proceed using the multilingual codebook at step 404. The speech recognition processing may make use of a Hidden Markov Model (HMM) to realize speech reconnection in the form of vector quantization. In particular, a different trained HMM may be used for each language represented in the multilingual codebook.

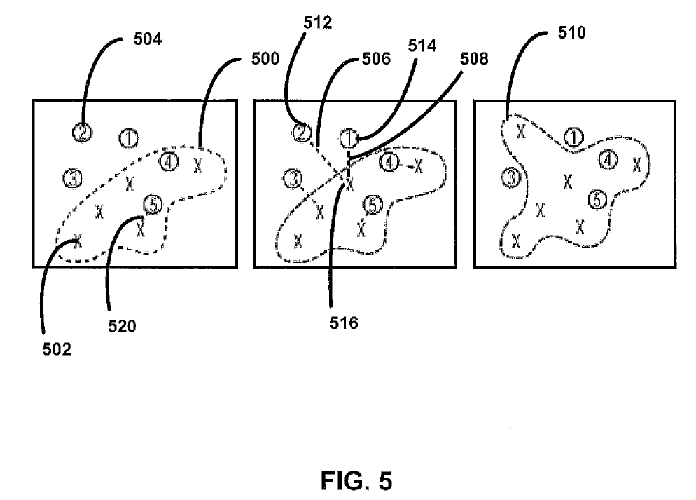

FIG. 5 is a schematic diagram illustrating operation of an example method for generating a multilingual codebook. FIG. 5 shows a main language codebook 500 having code vectors 502 (indicated by X's) in FIG. 1. The main language codebook 500 may be previously generated by the LBG algorithm, for example. Typically, the code vectors represent Gaussians within a Gaussian mixture model, which allows for speech recognition in the form of vector quantization employing an HMM recognizer trained for the German language (for example). The main language codebook 500 is thus provided for speech inputs in the German language.

In the illustrated example, the multilingual codebook is represented by the dashed contour of FIG. 1 that represents the area in feature space covered by the Gaussians. Initially, this space is the main language codebook 500. FIG. 1 also shows additional code vectors (encircled numerals 1-5) 504 of one additional codebook for a language different from the main language. Additional code vectors enumerated as encircled 4 and 5 lie within the area indicated by the dashed contour. Code vectors enumerated as encircled 1, 2 and 3 of the additional codebook lie outside this area thus representing sound patterns (or features) that are typical for the additional language and different from the main language. Such sound patterns are also not similar to any of the code vectors 502 of the main language codebook 500 corresponding to the main language.

As described above with reference to FIGS. 1 and 2, distances between the code vectors 504 of the additional codebooks and the respective closest code vectors 502 of the main language codebook are determined as indicated by the dashed connecting lines. In the example illustrated in FIG. 1, code vectors 1 and 2, 514 and 512, respectively, have the same closest neighbor 516 in the main language codebook 500. The distance between additional code vector 512 and closest neighbor 516 is shown as distance 506 in FIG. 5. The distance between code vector 514 and 516 is shown in FIG. 5 as distance 508. The distances between the code vectors 504 (enumerated as encircled 1-5) and the code vectors X 502 of the main language codebook 500 may be determined by distance measures known in the art, such as for example, some Euclidean distance, the Mahalanobis distance or the Kullback-Leibler divergence. Alternatively, the distances may be determined by minimizing the gain in variance when a particular additional code vector is merged with different particular code vectors of the main language codebook; that is, the respective code vectors, for example, 1 and the closest one of the X's, are replaced by a code vector that would have been estimated from the training samples of both the main language codebook and the additional codebook that resulted in the particular estimations of the code vectors that are merged.

After the distances have been determined, the code vector that shows the largest distance to the respective closest code vector X of the main language codebook is added to the main language codebook 500. In the example shown in FIG. 5, code vector 512 is added to the main language codebook 500 because its distance 506 is greater than the distance 508 between additional code vector 514 and closest neighbor 516. The code vector 512 would result in the largest vector quantization error when a speech input of the language corresponding to the additional codebook is to be recognized. The main language codebook with the added code vector 512 is shown in FIG. 5 as codebook 510, which ultimately becomes the multilingual codebook 510.

By including code vector 512 in the iterated main language codebook 500, the recognition result of a speech input of the language corresponding to the additional codebook may be improved. Further iterations resulting in the inclusion of further code vectors of the additional codebook in the main language codebook will further reduce vector quantization errors for utterances in the language corresponding to the additional codebook. In each iteration step the code vector of the additional code book is added to the multilingual codebook that exhibits the shortest distance to its closest code vector neighbor of the main language codebook.

Code vectors of further additional codebooks representing other languages may also be included in the original main language codebook. By these iterations the main language codebook develops into a multilingual codebook 510. For each language, an HMM speech recognizer is then trained based on the resulting multilingual codebook. Each HMM is trained with the corresponding language (code vectors of the corresponding language) only.

The resulting multilingual codebook 510 (FIG. 5) may include the entire original main language codebook (all code vectors X). This would allow for any recognition result of an utterance in the language corresponding to the main language codebook based on the resulting multilingual codebook to be as reliable as a recognition result of an utterance in that language based on the original main language codebook. In addition, the Gaussians of the main language codebook are not altered at all with the possible exception of the merging of code vectors of additional codebooks that are very close to the main language codebook.

It is noted that there may be code vectors of additional codebooks that are very similar (or close) to code vectors of the main language codebook. In the example shown in FIG. 1, code vector 5 exhibits a small distance 520 to its closest neighbor X. When a distance of a code vector of an additional codebook to the closest neighbor of the main language codebook or an already iterated multilingual codebook lies below some suitably chosen threshold the respective code vectors are merged in order to avoid redundancies caused by similar sounds of different languages. This further minimizes the total number of code vectors.

For example, one may start from a main language codebook representing feature vectors for the German language. Then, additional codebooks for the English, French, Italian and Spanish languages are added and a multilingual codebook is generated as it is described above. Each of the codebooks may be generated using the well-known LBG algorithm. The multilingual codebook may include some 1500 or 1800 Gaussians, for example. The influence of each of the additional codebooks can be readily weighted by the number of code vectors of each of the codebooks.

When starting with a main language codebook for German having 1024 code vectors, the generation of a multilingual codebook having the same 1024 code vectors for German and an additional 400 code vectors for English, French, Italian and Spanish has been shown to provide suitable recognition results for utterances in any of the mentioned languages. In addition, such results may be obtained without degrading speech recognition of German utterances with respect to the recognition of German utterances based on the main language codebook for German comprising the 1024 code vectors. Such results have also been obtained with relatively small increases in computational costs and memory demand while resulting in significantly improved multilingual speech recognition.

It will be understood, and is appreciated by persons skilled in the art, that one or more processes, sub-processes, or process steps described in connection with FIGS. 1, 2 and 4 may be performed by a combination of hardware and software. The software may reside in software memory internal or external to a processing unit, or other controller, in a suitable electronic processing component, or system such as one or more of the functional components or modules depicted in FIG. 3. The software in memory may include an ordered listing of executable instructions for implementing logical functions (that is, “logic” that may be implemented either in digital form such as digital circuitry or source code or in analog form such as analog circuitry), and may selectively be embodied in any tangible computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store, communicate, propagate, or transport the program for use by or in connection with the instruction execution system, apparatus, or device. The computer readable medium may selectively be, for example, but is not limited to, an electronic, magnetic, optical, electromagnetic, infrared, or semiconductor system, apparatus, device, or medium. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic), and a portable compact disc read-only memory “CDROM” (optical) or similar discs (e.g., DVDs and Rewritable CDs). Note that the computer-readable medium may even be paper or another suitable medium upon which the program is printed, as the program can be electronically captured, via, for instance, optical scanning or reading of the paper or other medium, then compiled, interpreted or otherwise processed in a suitable manner if necessary, and then stored in the memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method for generating a multilingual codebook comprising:
providing a main language codebook;
providing at least one additional codebook corresponding to a language different from the main language; and
generating a multilingual codebook from the main language codebook and the at least one additional codebook by adding a sub-set of code vectors of the at least one additional codebook to the main codebook based on distances between the code vectors of the at least one additional codebook to code vectors of the main language codebook.

2. The method of claim 1 further comprising:
determining distances between code vectors of the at least one additional codebook and code vectors of the main language codebook; and
adding at least one code vector of the at least one additional codebook to the main language codebook having a predetermined distance from the code vector of the main language codebook that is closest to the at least one code vector.

3. The method of claim 1 further comprising:
merging a code vector of the at least one additional codebook and a code vector of the main language codebook when the distance between them lies below a predetermined threshold.

4. The method of claim 3 further comprising:
adding the merged code vector to the main language codebook.

5. The method of claim 1 further comprising:
generating the main language codebook and/or the at least one additional codebook based on utterances by a particular user.

6. The method of claim 1 further comprising:
processing the code vectors of the codebooks according to a Gaussian density distribution.

7. The method of claim 1 further comprising:
determining the distances based on either the Mahalanobis distance or the Kullback-Leibler divergence.

8. A method for speech recognition comprising:
providing a multilingual codebook generated by a method comprising:
providing a main language codebook;
providing at least one additional codebook corresponding to a language different from the main language; and
generating a multilingual codebook from the main language codebook and the at least one additional codebook by adding a sub-set of code vectors of the at least one additional codebook to the main codebook based on distances between the code vectors of the at least one additional codebook to code vectors of the main language codebook;
detecting a speech input; and
processing the speech input for speech recognition using the provided multilingual codebook.

9. The method of claim 8 where the method of providing a multilingual codebook further comprises:
determining distances between code vectors of the at least one additional codebook and code vectors of the main language codebook; and
adding at least one code vector of the at least one additional codebook to the main language codebook having a predetermined distance from the code vector of the main language codebook that is closest to the at least one code vector.

10. The method of claim 8 where the method of providing a multilingual codebook further comprises:
merging a code vector of the at least one additional codebook and a code vector of the main language codebook when the distance between them lies below a predetermined threshold.

11. The method claim 10 where the method of providing a multilingual codebook further comprises:
adding the merged code vector to the main language codebook.

12. The method of claim 8 where the method of providing a multilingual codebook further comprises:
generating the main language codebook and/or the at least one additional codebook based on utterances by a particular user.

13. The method of claim 8 where the method of providing a multilingual codebook further comprises:
processing the code vectors of the codebooks according to a Gaussian density distribution.

14. The method claim 8 where the method of providing a multilingual codebook further comprises:
determining the distances based on either the Mahalanobis distance or the Kullback-Leibler divergence.

15. The method of claim 8 further comprising:
processing the speech input for speech recognition includes speech recognition based on a Hidden Markov Model.

16. A speech recognition system comprising:
a codebook generator configured to generate a multilingual codebook by accessing a main language codebook and at least one additional codebook corresponding to a language different from the main language, and by adding a sub-set of code vectors of the at least one additional codebook to the main codebook based on distances between the code vectors of the at least one additional codebook to code vectors of the main language codebook.

17. A vehicle navigation system comprising:
a speech recognition having a codebook generator configured to generate a multilingual codebook by accessing a main language codebook and at least one additional codebook corresponding to a language different from the main language, and by adding a sub-set of code vectors of the at least one additional codebook to the main codebook based on distances between the code vectors of the at least one additional codebook to code vectors of the main language codebook.

18. An audio device comprising:
a speech recognition having a codebook generator configured to generate a multilingual codebook by accessing a main language codebook and at least one additional codebook corresponding to a language different from the main language, and by adding a sub-set of code vectors of the at least one additional codebook to the main codebook based on distances between the code vectors of the at least one additional codebook to code vectors of the main language codebook.

19. A mobile communications device comprising:
a speech recognition having a codebook generator configured to generate a multilingual codebook by accessing a main language codebook and at least one additional codebook corresponding to a language different from the main language, and by adding a sub-set of code vectors of the at least one additional codebook to the main codebook based on distances between the code vectors of the at least one additional codebook to code vectors of the main language codebook.
